(19) United States
(12) Patent Application Publication
(10) Pub. No.: US 2004/0098522 A1
(43) Pub. Date: May 20, 2004

(54) Apparatus and method for retrieving and displaying related information on a handheld communication device

(76) Inventors: Karen Holtzblatt, Sudbury, MA (US); Hugh Beyer, Temple, NH (US); David Rondeau, Stoneham, MA (US)

Correspondence Address: Burns & Levinson LLP, Suite 300, 1030 Fifteenth Street N.W., Washington, DC, 20005-1501, US

(21) Appl. No.: 10/667,047

(22) Filed: Sep. 22, 2003

Related U.S. Application Data
(60) Provisional application No. 60/412,744, filed on Sep. 23, 2002.

(51) Int. Cl. G06F 13/12

(52) U.S. Cl. 710/73

(57) ABSTRACT

An information retrieval and display system and method enables users of a portable handheld communication device to easily access information about related sets of objects by providing users a multi-pane Object Browser.

### PRIORITY

The present application for United States Patent claims priority from provisional application for U.S. Patent Serial No. 60/412744, filed on Sep. 23, 2002.

### FIELD OF THE INVENTION

The present invention relates to the field of portable handheld communication devices, such as wireless telephones and personal digital assistants (PDAs) that access information through wireless communication with a remote server or through synchronization with a personal computer. More particularly, the present invention relates to a human-machine interface for user interaction with information displayed on a portable handheld communication device.

### BACKGROUND OF THE INVENTION

Portable hand-held communication devices that have capability to access and display information enable users to have access to a wide range of information while a user is on the move. Currently, content delivery to mobile devices can be implemented in two ways: with a markup language such as WML (Wireless Markup Language) used in the Wireless Application Protocol (WAP) and Compact HTML (cHTML), or with a portable application programming language such as Java. With WAP, a simple browser application built into a mobile device may display information downloaded over a wireless or other type of data link. WAP on a mobile device is limited to providing static web browsing and basic graphics capabilities. a model that precludes the delivery of dynamic, interactive, and personal content.

Mobile device users want content delivery services and applications that enable them to quickly access and compare information that meet their own individualized needs. For example, a user in a new city may want to view restaurants in close vicinity to them. They may want to see where those restaurants are relative to their current location and then compare and contrast those restaurants in terms of price, quality, or menu selection. WAP based interfaces lack the flexibility to provide users easy access to information that meet their own individualized needs. In contrast, portable application programming languages such as Java, enable developers to write rich dynamic personalized applications for use on mobile devices. Nevertheless, application developers for small screen devices face the challenge of providing users a user interface that enables them to productively meet their information needs.

Because the screen size of these small devices is very limited, using handheld communication devices productively as a tool for viewing information presents challenges for users of this technology. Users are typically able to view only a relatively small amount of information on a single screen. If a user wishes to compare or contrast related information or acquire more detailed information about a specific item, they must navigate through multiple screens. This process is often tedious and frustrating.

Consider the problems faced by a user of a conventional hand-held city guide application. Suppose that the user is interested in comparing different restaurants in a city. The application may present them a list of French restaurants. But in order to get more detail about each restaurant, the user must move back and forth between two or more screens, one containing the list of restaurants and the other(s) containing detailed information about each restaurant.

These problems are further exacerbated when users want to access a wide range of different types of related information about a specific on-going event such as a sports event. For example, users accessing play-by-play updates of a baseball game, may want to access statistics about specific players on each team; the line-ups of each team, or the play-by-play events of previous innings. In order to view the wide range of information about an event they want to access, users often need to traverse multiple menus and screens.

These problems limit the utility of hand-held communication devices as a tool for exploring a wide range of inter-related information. Therefore, there is a need for an improved method and system that to enable users to efficiently and easily navigate through related information while using a handheld communication device.

### SUMMARY OF THE INVENTION

The present invention is a system and method that solves the above-described problems in small screen user interface design. The present invention uses portable application programming technology such as Java to provide users of a portable handheld communication device a method and system to easily navigate through information about inter-related sets of objects.

The system comprises a handheld communication device that accesses information from a remote server and displays information on a display screen. The handheld communication device provides users a control mechanism through which users can interact with information displayed on the screen and initiate requests for additional information that is stored either locally on a storage mechanism in the device or remotely on a server. The portable communication device accesses information from the remote server via wireless communication with the device. Information accessed from the server may be stored in temporary storage on the portable communication device's data storage mechanism. The device operates in response to user interactions in accordance with program instructions stored in the device.

Handheld portable communication devices use one of several different control mechanisms for enabling users to select objects displayed on a screen, including a pointing device such as a stylus, soft keys, buttons (e.g., an up-button, down-button, right-button, left-button), scroll wheel, or keys on a keyboard. Accordingly, the examples of use of the user interface presented below should be regarded as illustrative only and should in no way be seen as limiting the broader scope of the present invention.

According to the invention, a portable handheld communication device has an associated user interface that displays an Object Browser. An Object Browser divides a screen display into two types of screen areas or panes: a navigation pane displaying one or more visual objects, said pane enabling a user to select the object the user wants more information about, and an information pane that displays detailed information about an object. An Object Browser enables a user to easily access information about specific objects and compare and contrast information about inter-set sets of objects.

The navigation pane displays a set of objects. Objects include categories (e.g., types of merchandise), entities (e.g., ball players, restaurants, products) events (e.g., a baseball game, a meeting ) or collections of categories, entities or events. An object is represented on a navigation pane as a word, number, letter(s), or graphic image. The objects displayed in a navigation pane are members of a common type, category or class of objects. For example, the objects displayed in a navigation pane may all be players on a baseball team or all French restaurants in a city. Users can access more detailed information about each object by selecting that object. Detailed information about the selected object is displayed in the information pane. By successively selecting different objects from the navigation pane, a user is able to easily compare and contrast information about related objects, such as the statistics of different ball players or reviews of different French restaurants in a city.

The objects in a navigation pane may represent collections of objects. Such objects are referred to as collection objects. When a user selects a specific collection object, the items contained in the collection object are displayed in the information pane. For example, a menu is a collection object containing different food items. The navigation pane may list menus from different restaurants. As a user selects each menu, items from that menu will be displayed in the information pane.

An information pane displays detailed information about an object or the contents of a collection object. Information displayed about an object may be static or dynamically updated by accessing new information from the server. For example, if a specific baseball player is selected in a navigation pane, the information pane may display his batting statistics that are accessed from the information base. This information is static because it does not change while displayed to the user. On the other hand, if a baseball inning is selected in a navigation pane, descriptions of each play that occurred in the inning may be displayed in the information pane. If the selected inning is on going, the information displayed in the information pane will be dynamically updated as each new play in the inning occurs. The displayed information is dynamically updated by new information accessed from the server.

Users are able to view more detailed information about objects displayed in an information pane by opening up a new Object Browser. Users open a new object browser by first selecting an object in the information pane. For example, descriptions of a baseball play may be displayed in the information pane (e.g. “Ramirez singles to left”). The description of the play may refer to a specific baseball player (e.g., Ramirez). If a user wants to access additional information about the baseball player they select the baseball player's name and then open a new Object Browser that will display detailed information about the selected player.

When a user opens a new Object Browser, the new Object Browser will display a navigation pane and an information pane. The navigation pane will list the selected object (e.g., the ball player) and other related objects (e.g., other players on the team). When the Object Browser is first displayed, detailed information about the selected object (e.g., player) will be displayed in the information pane. Users may select other related objects in the navigation pane to compare and contrast detailed information about the related objects.

An Object Browser may include more than one navigation pane. For example, an object browser may include a navigation pane the lists the innings in baseball game and a navigation pane that represents the ball players on a playing field. The same information pane may be used to display information about either ball players or plays in an inning.

### BRIEF DESCRIPTION OF THE DRAWINGS

FIG. 1 is a block diagram of the information retrieval and display system of this invention.

FIG. 2 is a block diagram of the portable handheld communication device of the system in FIG. 1.

FIG. 3 illustrates one example of a handheld communication device configured with a Object Browser, a four-way navigation button and two soft keys that is an embodiment of the present invention.

FIG. 4 illustrates a second example of a handheld communication device in which the Object Browser enables users to access information about baseball games played on a selected date.

FIG. 5 illustrates the result of a user interaction with the Object Browser displayed in FIG. 4 in which the user activates the information pane in the Object Browser.

FIG. 6 illustrates an example of an Object Browser configured in accordance with an embodiment of the present invention with two navigation panes and one information pane.

FIG. 7 illustrates the result of a user interaction with the Object Browser displayed in FIG. 6 in which the user activates the second navigation pane in the Object Browser.

FIG. 8 illustrates an example of a user interaction in which a user opens a new Object Browser.

FIG. 9 illustrates the result of “maximizing” the size of the information pane displayed in an Object Browser.

### DETAILED DESCRIPTION OF THE PREFERRED EMBODIMENTS

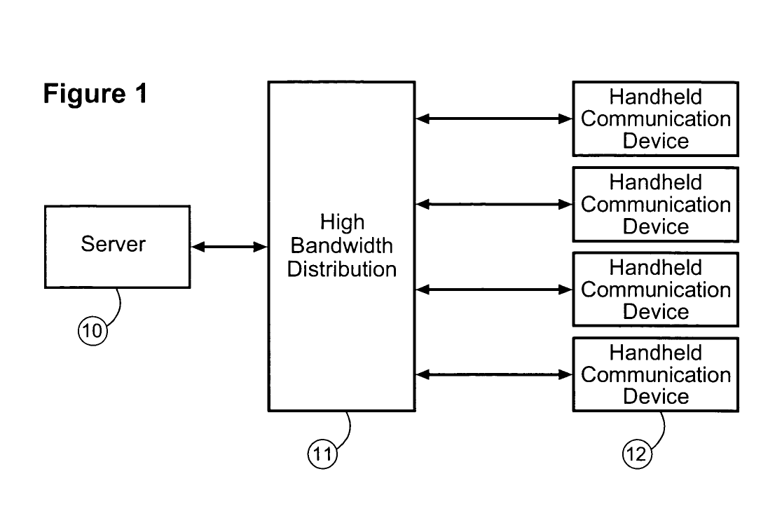

Described herein is a system and method for retrieving and displaying information on a handheld portable communication device such as a wireless telephone or personal digital assistant (PDA). FIG. 1 illustrates the components of an information retrieval and display system in which the present invention may be embodied. The system illustrated in FIG. 1 comprises a server 10 coupled to a high bandwidth distribution system 11, such as a local or wide area computer network, private or telecommunication circuits, or the Internet and a plurality of handheld communication devices 12, each connected via the distribution system 11. The server stores information in an information base. Each handheld communication device is able to request information from the server 10 by communicating wirelessly via the distribution system 11. In response to such requests, the server 10 downloads appropriate information to the relevant handheld communication device 12 through the distribution system 11. The protocols for data communication between a communication device and server via a distribution system are known. However, they currently vary amongst known techniques. The present invention is not limited to any particular protocols.

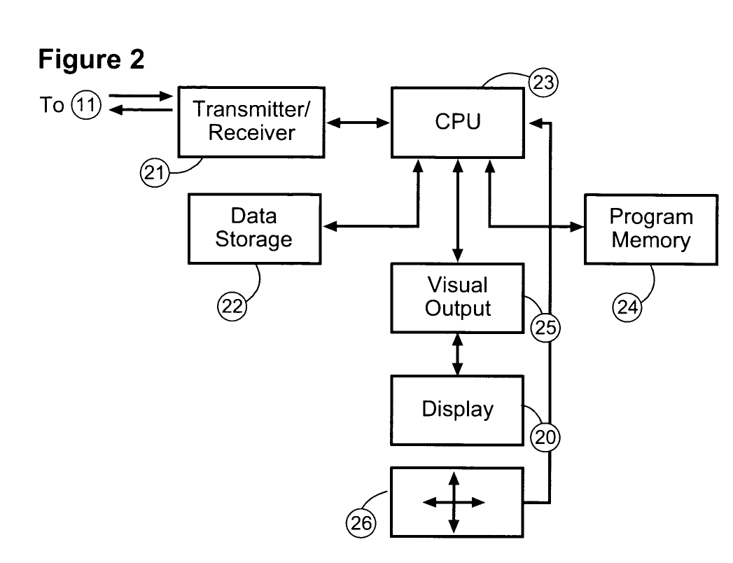

FIG. 2 shows the key elements within a handheld communication device 12. Each handheld communication device 12 consists of a conventional display apparatus 20, a transmitter/receiver system 21, a data storage system 22, a central processing system (CPU) 23, a program memory 24, a visual output system 25, and a control apparatus 26. The transmitter/receiver system 21 communicates with the distribution system 12 for transmitting requests for data from the server and for receiving data from the server. The data storage system 22 provides temporary storage for data that is downloaded from the server 12.

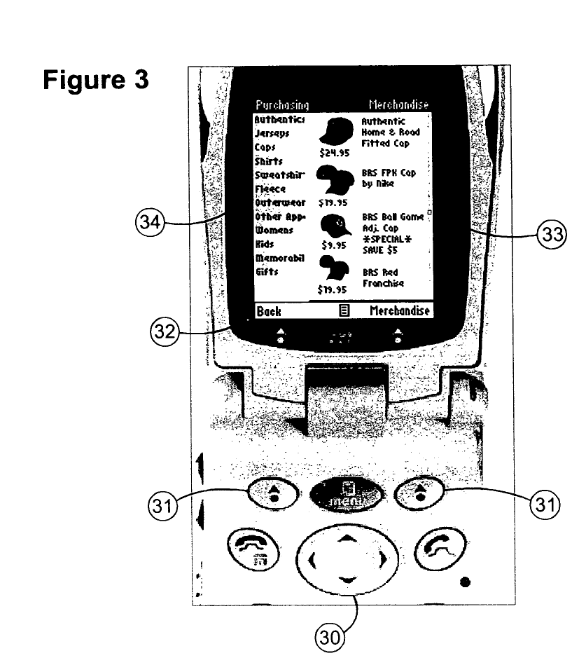

The user interacts with the device by selecting items displayed on the display apparatus 20 by using the control apparatus 26. In one embodiment of this invention (see FIG. 3) the control unit consists of a four-way navigational button 30 and two soft keys 31. The four-way navigation button allows the user to select items displayed on the screen by moving left, right, up, or down. The two soft keys allow the user to perform specific operations. The operations performed by the soft keys will vary depending on the context. Labels on the screen directly above the soft keys identify for a user the operation that will be performed by using the soft key. For example, the label 32 (“Back”) identifies to a user that the operation performed by the soft key will open the previous Object Browser.

Other embodiments of this invention will use other control mechanisms such as a pointing device (e.g., a stylus), a two-way navigational button, a scroll wheel or a keyboard. Accordingly, the examples of use of the user interface presented below should be regarded as illustrative only and should in no way be seen as limiting the broader scope of the present invention.

The CPU 23 processes inputs from the control mechanism in accordance with software byte-code instructions stored in program memory 24. In one embodiment, the software byte-code instructions may comprise byte-codes supported by the VM (Virtual Machine) functionality of a software support layer (not shown). In one embodiment, the byte-codes comprise Java or Java-like byte-codes. In one embodiment, the CPU 23 may execute macro-instructions under control of the software support layer, or each macro-instruction may be translated into a sequence of micro-instructions that may be executed directly by the CPU 23.

In one embodiment, the software layer may provide its own operating system functionality. The software support layer may implement or operate within or alongside a Java or Java-like virtual machine (VM), portions of which may be implemented in hardware. In one embodiment, portions of the VM, not included as the software support layer, may be included as hardware. In one embodiment, the VM may comprise a Java or Java-like VM embodied to utilize Micro Edition (J2ME.TM.) programming platforms available from Sun Microsystems. J2ME provides a standard subset of Java programming features for programming platforms that have limited memory and power resources (i.e., including but not limited to cell phones, PDAs, etc).

In the present invention, program memory includes user interface instructions that contain logic for generating the user interface. The user interface logic divides the display screen into screen areas, known as panes. A pane may be rectangular, square, elliptical, circular, or any other appropriate shape. The screen is divided into two types of panes: a navigation pane and an information pane. Each type of pane manifests distinct behavior in response to user interactions with items displayed on the screen. The techniques for using program logic to divide a screen into two or more screen areas, each manifesting distinct behavior, are known. The present invention applies these techniques by defining specific behavior for interacting with items displayed on each screen area. By providing well-defined behaviors for each screen area, the user is provided a system and method for easily accessing information about specific sets of inter-related objects.

In the present invention, the screen is divided into one or more navigation panes and an information pane. The configuration of navigation panes and information pane into which a screen is divided is referred to as an Object Browser.

FIG. 3 illustrates an example of an Object Browser that consists of one navigation pane 34 and one information pane 33. A navigation pane 34 displays a set of items that represents objects, categories of objects, or collections of objects, about which a user may want additional information. An object is an entity, an event, a category of entities or events, or a collection of entities, events or categories. In this example, the navigation pane 34 displays a list of categories of merchandise such as caps, shirts, or sweatshirts, which are available for sale. In this example, a user selects an item from the navigation pane 34 by using the four-way navigation button 30 to move from one item to the next item in the navigation pane 34.

When a user selects an item in a navigation pane 34, information about that item will appear in the information pane 33. For example in FIG. 3, if a user selects a specific category of merchandise for sale (e.g., caps) in navigation pane 34, specific caps available for sale are displayed in the information pane 33.

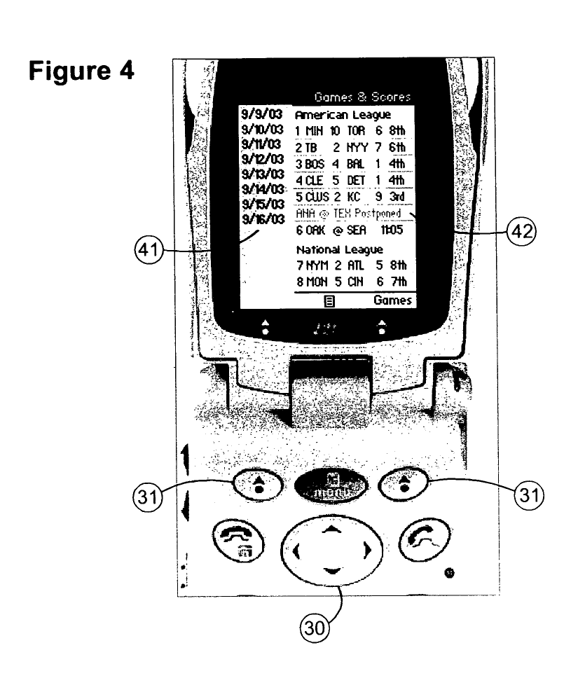

FIG. 4 illustrates a second example of an Object Browser. In this example the navigation pane 41 lists a set of dates. Each date represents a set of games either already played or scheduled for that date. In the example, the date “Sep. 10, 2003” is selected in navigation pane 41. The list of baseball scores for “Sep. 10, 2003” are displayed in the information pane 42. A user may move from the currently selected date to the preceding or following date by depressing the four-way navigation button 30 up or down. As the currently selected date is changed through user interaction, lists of game scores corresponding to each selected date are displayed in the information pane 42.

In the present invention, users can access additional information about objects displayed in an information pane, by selecting objects displayed in the information pane and opening a new Object Browser with detailed information about the selected object displayed in the Object Browser.

In the embodiment of the invention illustrated in FIG. 4 in which the control mechanism uses a four navigation button and two soft keys, a user must activate a pane before they can select an object displayed on that pane. In a preferred embodiment of this invention, the currently activated pane is highlighted to the user through a border. In FIG. 4, a yellow border around navigation pane 41 indicates to the user that this pane is active. In a preferred embodiment of this invention the user activates a pane by using a soft key. In FIG. 4 the user can activate the information pane 42, by select soft key 31. The soft key 31 is labeled on the screen with label “Games” that identifies it as the appropriate soft key for activating information pane 31. In another embodiment of this invention, the information pane can be activated by using the four-way navigation button. In this embodiment of the invention, the information pane 31 is activated by the user depressing the right button of the four-way navigation button 30 indicating that the pane on the right should be activated.

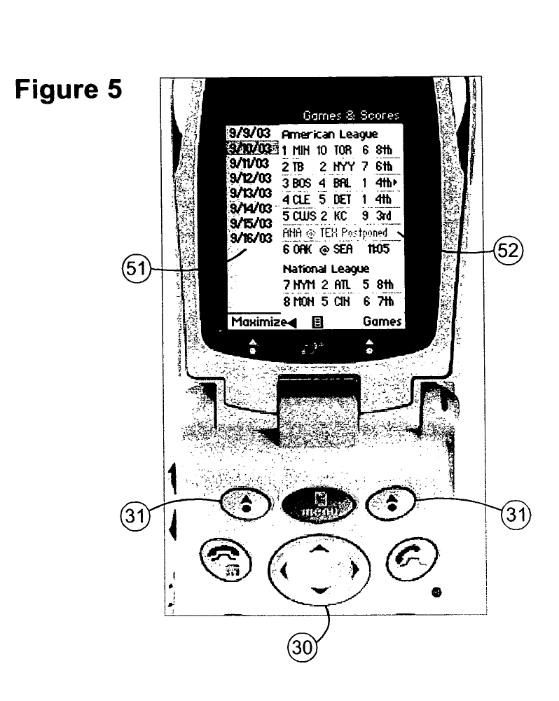

FIG. 5 illustrates the result of activating information pane 52. The information pane 52 now has a yellow border around it indicating that it is the active pane. After an information pane is activated, a user is able to select objects that are displayed on the pane. The objects displayed in the information pane 52 in FIG. 5 represent different baseball games played on a specific date. In one embodiment of this invention, users select an object by using the four-way navigation button 30. A user navigates from one object to the next object by using the up and down buttons on the four-way navigation button. In the example in FIG. 5, the game between Baltimore and Boston is selected, indicated by highlighting that game.

After an object is selected in the information pane, a new Object Browser can be opened by performing a “Open Object Browser” operation on the selected object. The new Object Browser will display detailed information about the selected object. In FIG. 5, an “Open Object Browser” operation is performed on the selected game by using the right button on the four-way navigation.

In accordance with a preferred embodiment of this invention, when a user opens a new Object Browser (or when an Object Browser is automatically opened), the handheld communication device sends a request to the server 12 for information about every object that will be displayed in the Object Browser. The information is stored in data storage system 22 of the handheld device. This ensures fast retrieval of information when an object is selected in the Object Browser. In the example, in FIG. 5, when a “Open Object Browser” operation is performed, the handheld communication device sends a request for information about the seasonal and game statistics of every player on each team in the game and information about each pitch and play in the game. This information is sent to the handheld communication device from the server 12 and is stored in the data storage system 22 of the handheld communication device. In some embodiments of this invention, the system may also request additional information about an object after the Object Browser is opened.

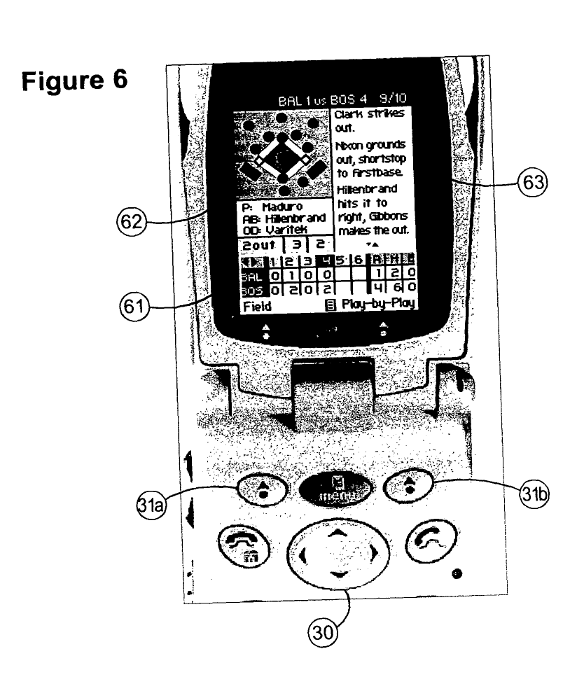

FIG. 6 illustrates the result of opening a new Object Browser with the selected game. In FIG. 6, the new Object Browser consists of 2 navigation panes, navigation pane 61 and navigation pane 62.

Both navigation panes (61 and 62) in FIG. 6 embed selectable items in a graphic layout that communicates additional information to a user. Navigation pane 61 is a scoreboard that displays to users runs scored by a team in each inning. The selectable items displayed in navigation pane 61 in this example are the innings of a game. Users can interact with the scoreboard to select an inning in order to view play-by-play information for that inning in the information pane 63. Each inning is represented by a number on the scoreboard. By depressing the four-way navigation button 30 left or right, a user can move from a currently selected inning to an inning that is to the left or right of the currently selected inning. For example, if a user wants to see the play-by-play details of a previous inning, a user selects that past inning. A play-by-play summary for that inning is displayed in information pane 63.

In the example illustrated in FIG. 6, the handheld communication device periodically requests information on new plays. If new information is available, server 12 downloads all new information via distribution system 11 to the handheld communication device, which stores that information in data storage mechanism 22. This new information will be immediately displayed to the user if the user has selected the current inning in the ball game. Otherwise, the information will be displayed to the user when they select the inning that the information pertains to.

Navigation pane 62 enables users to access information about players on each team. The navigation pane displays a playing field with selectable items displayed on the field. Each player is represented as a graphic symbol (e.g., a small circle) on the playing field. In this example, each circle represents a player on the field, on base, at bat or on-deck. In addition, the two rectangles (red and blue) represent the line-ups of each team. By depressing the four-way navigation button 30 left, right, up, or down; a user traverses from graphic symbol to another graphic symbol. When the user selects the graphic symbol representing a player, detailed information about that player appears in the information pane 63.

In the example in FIG. 6, navigation pane 61 is active. If a user wants to select a player on the playing field, the user will need to activate navigation pane 62. In one embodiment of this invention, the user can activate this pane by using a soft key. In the example in FIG. 6, the user can use the soft key 31 (a) labeled “Field” to activate the navigation pane 62.

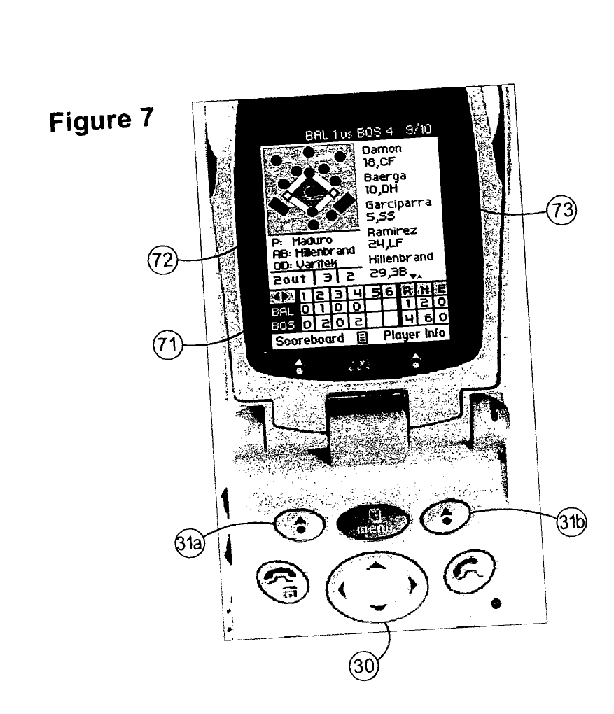

FIG. 7 shows the result of a user activating navigating pane 72. The user can now select objects in this pane. In this example, the user selects the red rectangle, which represents the Boston Red Sox starting line up. The line-up is displayed in information pane 73. If a user wants to access more detailed information about a player in the line-up, they must activate the information pane 73. In FIG. 7 the user can activate the information pane 73, by using the soft key 31 (b) which is labeled “player info.”

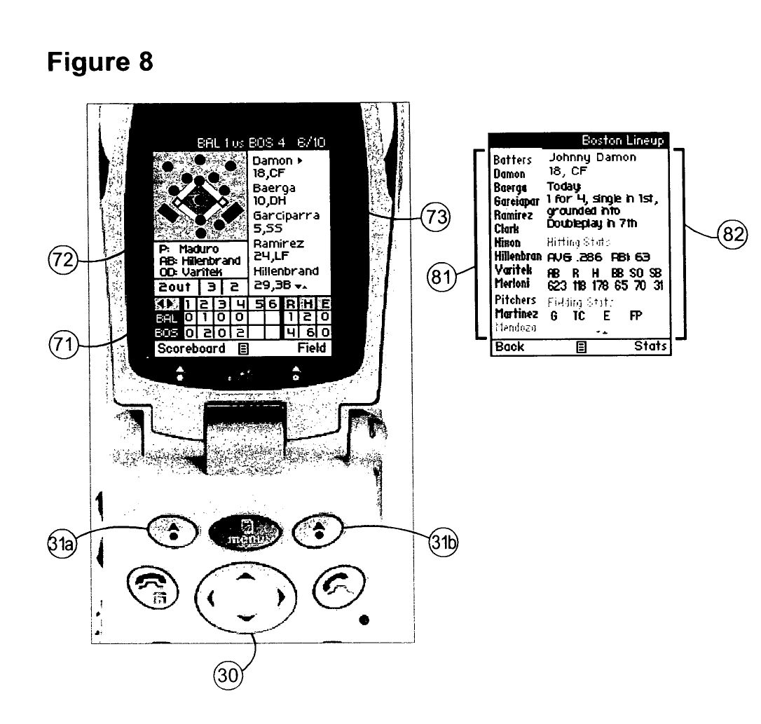

FIG. 8 illustrates the result of activating information pane 63. The user can select players in the information pane by using the four-way navigation button 30. If a user wants to see more detailed information about a selected player (e.g. Damon), they must perform a “Open Object Browser” operation. In FIG. 8, the user performs an “Open Object Browser” operation by depressing the right button on the four-way navigation button 30. This opens a new Object Browser with detailed statistics about the selected player (Damon) displayed in the information pane 82.

In FIG. 8, each player in the line-up is represented in navigation pane 71 by contiguous letters such as LF; each set of contiguous letters representing a player's fielding position. A user can traverse from one symbol representing a player (e.g., LF) to another symbol above or below the selected link by depressing the four-way navigation button up or down. As a user moves to a new selected symbol, detailed information associated with that player is displayed in the information pane 82.

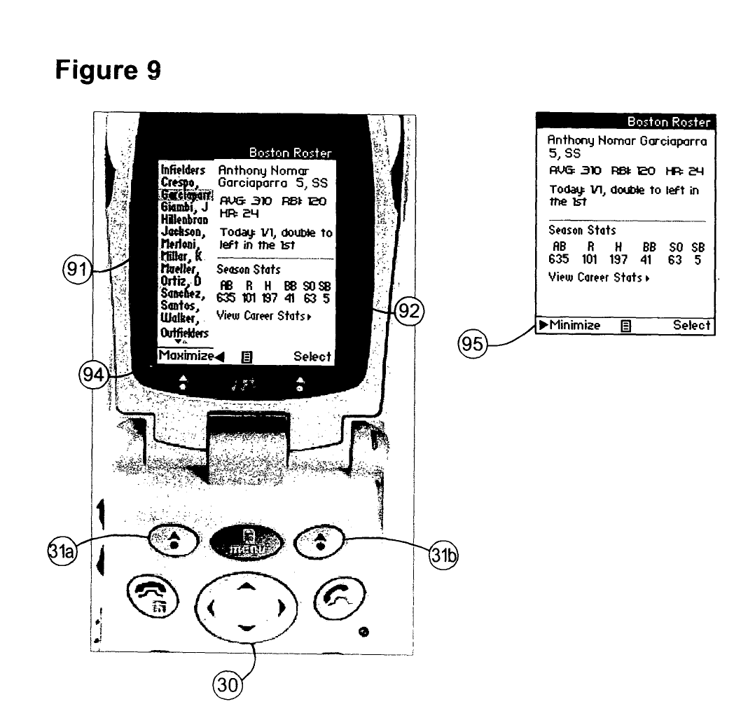

A user can adjust the size of a navigation and information pane through a user interaction operation. For example in FIG. 9, one of the soft-keys 94 is labeled Maximize. In this example, a user uses the soft key 31 (a) to maximize the size of the information pane 92. The information pane 93 illustrates the result of this user interaction operation. After performing a maximize operation, the soft key 31 (a) is now labeled Minimize (95). A user can revert the information pane 93 back to the size seen in information pane 92 by pressing soft key 31 (a).

In addition to the above examples, a variety of other applications that access and display information may be configured as embodiments of the present invention.

A user interface for a handheld communication device that includes a four-way navigation button and two soft keys has been described. Although discussed with respect to certain illustrated embodiments, those of ordinary skill in the art will appreciate that various modifications may be made to the systems described herein and that such modifications would represent insubstantial differences from the broader scope of the present invention. Accordingly the invention should only be measured in terms of the claims that follow.

We claim:

1. An apparatus for navigating electronically through and retrieving related information comprising:
a) a server storing information to be retrieved;
b) a portable handheld communication device having:
i) at least one memory device capable of storing instructions and information from the server,
ii) a display, and
iii) a control mechanism;
c) a communications link between the portable handheld communication device and the server; and
d) byte code instructions stored in the communications device memory device that
i) divide the display into at least one navigation pane and at least one information pane, thereby creating an Object Browser;
ii) establish at least one object comprising characters or graphics in the at least one navigation panel;
iii) either
(1) establish at least one object in the at least one information pane; or
(2) display retrieved information in the at least one information pane;
iv) enable a user of the handheld communications device to select a pane;
v) enable a user of the handheld communications device to select an object when the pane that contains the object is selected;
vi) retrieve from the server information related to a selected object; and
vii) displays the retrieved information on the at least one information pane.

2. The apparatus of claim 1 in which the communications link between the portable handheld communication device and the server comprises a wireless telephone link.

3. The apparatus of claim 1 in which the communications link between the portable handheld communication device and the server comprises a mechanism for synchronization with a server.

4. The apparatus of claim 1 in which the control mechanism comprises a touch stylus or a plurality of buttons or a combination of touch stylus and a plurality of buttons.

5. The apparatus of claim 1 wherein displayed information comprises at least one form of information selected from the group of audio, text, graphic, video, and animation.

6. The apparatus of claim 1 further comprising instructions that activate a screen area wherein a user can select objects in the activated screen area.

7. The apparatus of claim 1 further comprising instructions that resize the size of the navigation and information panes upon activation of a designated portion of the control mechanism.

8. The apparatus of claim 1 further comprising
a) means for determining whether the size of the information pane is large enough to adequately display information selected for display in the information pane;
b) means for displaying a part of the page of information; and
c) means for scrolling information that is displayed in response to user input to move the displayed area.

9. In a handheld communication device having a display screen, a control mechanism through which a user interacts with the device, byte-code instructions enabling the device to respond to user interactions in accordance with the control mechanism, a communications link enabling the device to access information from a remote information base, and a storage system for storing data downloaded from the remote server, a method for displaying stored information about selected objects comprising the steps of:
a) displaying an Object Browser, wherein the Object Browser segments the display screen into at least two screen areas, at least one navigation pane, comprising an area for displaying symbols that represent objects, and at least one information pane, comprising an area for displaying information about selected objects;
b) selecting an object that is represented in the navigation pane;
c) retrieving information corresponding to the selected object; and
d) displaying the information retrieved about the selected object in the information pane.

10. The method of claim 9, wherein information concerning a selected object is retrieved from the remote server.

11. The method of claim 9, wherein information concerning objects represented in the navigation pane is downloaded from the remote server and stored in the storage system of the handheld communication device.

12. The method of claim 9, wherein the handheld communication device accesses information from a remote server via synchronization with a personal computer and stores information in the storage system of the handheld communication device.

13. The method of claim 9, wherein information concerning a selected object is retrieved from the storage system of the handheld communication device.

14. The method of claim 9 additionally comprising the steps of:
a) selecting an object displayed in an information pane;
b) receiving user input indicating an open Object Browser operation;
c) displaying a new Object Browser wherein the new Object Browser includes a navigation pane that displays symbols representing the selected object and other objects and an information pane that displays detailed information about the selected object.

15. The method of claim 9, wherein an object represents an event.

16. The method of claim 9 wherein the object represents an entity.

17. The method of claim 9 wherein the object represents a category of events or entities.

18. The method of claim 9, wherein the object represents a collection of events, entities, or categories.

19. The method of claim 9 wherein the Object Browser comprises at least two navigation panes.

20. The method of claim 9 further comprising the step of activating instructions for resizing the navigation and information panes using the control mechanism.

21. The method of claim 9 wherein a user selects an object with a key selection from a keyboard.

22. The method of claim 9, wherein a user opens an Object Browser by using a pointing device.

23. The method of claim 9 wherein a user opens an Object Browser by using a button.

24. The method of claim 23 wherein the button comprises one or more of: an up/down button, a two-way navigation button, or a four-way navigation button.

25. The method of claim 9 wherein a user opens an Object Browser with a key selection from a keyboard.

26. The method of claim 9 additionally comprising the step of activating a screen area wherein a user can traverse and select objects in the activated screen area.

27. The method of claim 26 wherein a screen area is automatically activated.

28. The method of claim 26 wherein a user activates a screen area by using a soft key.

29. The method of claim 26 wherein a user activates a screen area by depressing a button.

30. The method of claim 26 wherein a user activates a screen area with a key selection from a keyboard.
